(19) United States
(12) Patent Application Publication
(10) Pub. No.: US 2026/0233155 A1
(43) Pub. Date: Aug. 13, 2026

(54) PROCESS FOR CAPTURE AND CONVERSION OF CARBON DIOXIDE

(71) Applicant: THE GOVERNORS OF THE UNIVERSITY OF ALBERTA, Edmonton (CA)

(72) Inventors: Hongbo ZENG, Edmonton (CA); Yahui ZHANG, Edmonton (CA); Qi LIU, Edmonton (CA); Kaipeng WANG, Edmonton (CA)

(21) Appl. No.: 19/160,576

(22) PCT Filed: Feb. 28, 2024
(86) PCT No.: PCT/CA2024/050248

§ 371 Date: Aug. 28, 2025

Related U.S. Application Data
(60) Provisional application No. 63/487,510, filed on Feb. 28, 2023.

(51) Int. Cl. B01D 53/14; C01B 32/205; C22B 3/44

(52) U.S. Cl. CPC B01D 53/1475; C01B 32/205; C22B 3/44; B01D 2251/602; B01D 2257/504

(57) ABSTRACT

Embodiments herein generally relate to a process for capture of carbon dioxide (CO₂) and conversion to graphite or graphene. In at least one embodiment, the process comprises: capturing carbon dioxide (CO₂) using calcium oxide (CaO) to produce calcium carbonate (CaCO₃); recovering the carbon dioxide (CO₂) from the calcium carbonate (CaCO₃); and reacting the carbon dioxide (CO₂) with an active metal to produce graphite (C).

### CROSS-RELATED APPLICATIONS

The present application claims the priority benefit of U.S. Provisional Application 63/487,510, filed on Feb. 28, 2023, the entire contents of which are incorporated herein by reference.

### FIELD

The present invention generally relates to carbon capture technology, and more particularly, to a process for capture of carbon dioxide (CO₂) and conversion to graphite or graphene.

### BACKGROUND

Carbon capture technology has been proposed as a possible solution to mitigate the harmful effects of CO₂ emissions. Currently, many existing carbon dioxide capture or removal technologies employ adsorption-storage approaches. In most cases, carbon dioxide is only temporarily captured and stored in weak and unstable systems, such as carbon dioxide captured by mining tailings, zeolites, or activated carbon, which has the possibility of carbon dioxide releasing or escaping after certain time.

### SUMMARY OF VARIOUS EMBODIMENTS

In one broad aspect, there is provided a process for capture and conversion of carbon dioxide, comprising: capturing carbon dioxide (CO₂) using calcium oxide (CaO) to produce calcium carbonate (CaCO₃); recovering the carbon dioxide (CO₂) from the calcium carbonate (CaCO₃); and reacting the carbon dioxide (CO₂) with an active metal to produce graphite (C).

In some examples, recovering the carbon dioxide (CO₂) from the calcium carbonate (CaCO₃) is performed using calcination.

In some examples, the active metal is one of zinc (Zn), tin (Sn), manganese (Mn), Chromium (Cr), calcium (Ca), magnesium (Mg), aluminum (Al), titanium (Ti) and silicon (Si).

In some examples, an oxide of the active metal is produced as a byproduct of reacting the carbon dioxide (CO₂) with the active metal, and the process further comprises: recovery of the active metal from its oxide using a hydrometallurgy processes.

In some examples, the hydrometallurgy process comprises acid leaching followed by electrowinning.

In some examples, the recovered active metal is reused by reacting it with additional carbon dioxide (CO₂) to produce additional graphite (C).

In some examples, the calcium oxide (CaO) is generated as a byproduct of recovering the carbon dioxide (CO₂) from the calcium carbonate (CaCO₃), and the process further comprises: reusing the calcium oxide (CaO) to capture additional carbon dioxide (CO₂).

In some examples, prior to recovery of the carbon dioxide (CO₂), the process further comprises one or more of storing and transporting the captured and concentrated carbon dioxide (CO₂).

In some examples, the calcium oxide (CaO) comprises solid particles in a range of 1 nm to 100 microns.

In another broad aspect, there is provided a process for capture and conversion of carbon dioxide, comprising: capturing carbon dioxide (CO₂) using a metal oxide to produce a carbonate; recovering the carbon dioxide (CO₂) from the carbonate; and reacting the carbon dioxide (CO₂) with an active metal to produce graphite (C).

In some examples, the metal oxide is selected from the group consisting of MgO, FeO, MnO, ZnO, CuO, CaO, and mixtures thereof.

In some examples, recovering the carbon dioxide (CO₂) from the calcium carbonate is performed using calcination.

In some examples, the active metal is one of zinc (Zn), tin (Sn), manganese (Mn), Chromium (Cr), calcium (Ca), magnesium (Mg), aluminum (Al), titanium (Ti) and silicon (Si).

In some examples, an oxide of the active metal is produced as a byproduct of reacting the carbon dioxide (CO₂) with the active metal, and the process further comprises recovery of the active metal from its oxide using a hydrometallurgy processes.

In some examples, the hydrometallurgy process comprises acid leaching followed by electrowinning.

In some examples, the recovered active metal is reused by reacting it with additional carbon dioxide (CO₂) to produce additional graphite (C).

In some examples, the metal oxide is generated as a byproduct of recovering the carbon dioxide (CO₂) from the carbonate, and the process further comprises reusing the metal oxide to capture additional carbonate.

In some examples, prior to recovery of the carbon dioxide (CO₂), the process further comprises one or more of storing and transporting the captured and concentrated carbon dioxide (CO₂).

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is an example process for capture of carbon dioxide (CO₂) and conversion to graphite.

Further aspects and features of the example embodiments described herein will appear from the following description taken together with the accompanying drawings.

### DETAILED DESCRIPTION OF THE EMBODIMENTS

### I. Definitions

Any term or expression not expressly defined herein shall have its commonly accepted definition understood by a person skilled in the art. As used herein, the following terms have the following meanings.

“Active metals” refer to a class of metals, known in the art, that react strongly and quickly with other elements due to the electrons in their structure, and their ease of sharing the electrons with other elements. Examples of active metals include zinc (Zn), tin (Sn), manganese (Mn), Chromium (Cr), calcium (Ca), magnesium (Mg), aluminum (Al), titanium (Ti) and silicon (Si).

“Carbon capture” refers to the process of trapping and storing carbon (e.g., carbon dioxide in the atmosphere, often produced by burning of fossil fuels or other chemicals).

“Graphite” is an opaque, non-metallic carbon polymorph, represented by the element symbol (C).

“Graphene” is a one atomic layer of carbon atoms tightly bound in a hexagonal honeycomb lattice. It is an allotrope of carbon and is considered a form of graphite.

“Hydrometallurgy process” is a technique within the field of extractive metallurgy, involving the obtaining of metals from their ores. Hydrometallurgy involve the use of aqueous solutions for the recovery of metals from ores, concentrates, and recycled or residual material.

### II. General Overview

Embodiments described herein generally relate to a process for capture of carbon dioxide (CO₂) and the production of graphite or graphene.

The disclosed process involves capturing carbon dioxide (CO₂) using calcium oxide (CaO) powder, which is believed to provide an efficient and stable method for CO₂ capture. The process then subsequently involves conversion of the captured and concentrated carbon dioxide (CO₂) to graphite/graphene, using an active metal (e.g., Zn, Sn, Mn, Cr, Ca, Mg, Al, Ti, or Si).

The process combines the objectives of CO₂ reduction with the production of graphite. Graphite is considered to be an important, highly valued, but fast depleting mineral, which has broad applications in modern industries such as electrode materials in lithium batteries and electrometallurgy. In some embodiments, graphene is produced, which is also a valuable product.

It is believed that the disclosed process mitigates drawbacks associated with conventional carbon capture technology. More broadly, the disclosed process is regarded as relatively safe, technologically feasible and economically viable.

### III. Example Process

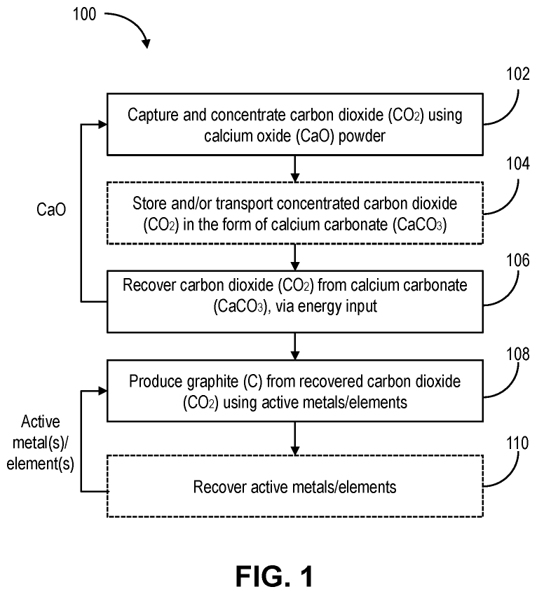

FIG. 1 shows an example process (100) for capture of carbon dioxide (CO₂) and conversion to graphite (or graphene).

As shown, at act (102), CO₂ is captured by reacting the CO₂ with calcium oxide (CaO) powder. This results is the production of solid calcium carbonate (CaCO₃), according to the reaction in Equation (1):

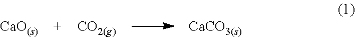

More generally, it has been appreciated that CaO is an efficient CO₂ capturer and concentrator. This is because the CaCO₃ forming reaction, expressed in Equation (1), can occur quickly and thoroughly. In some examples, higher specific areas or smaller particle sizes, of CaO powder (e.g., nano powder), may be more efficient for CO₂ capture, e.g., because of the increased surface area of the smaller particles. In at least one example, the grain sizes of CaO used in Equation (1) are in a range of 1 nm to 100 microns, which can be built/fixed together into certain shapes (e.g., bee hives). It has been appreciated that the smaller the CaO powder, the more efficient CO₂ capture. In some examples, the CO₂ capturing process in Equation (1) operates at the temperature and pressure of the flue gas containing CO₂. The CaO structure for CO₂ capture can be replaced after a certain elapsed time to maintain enough remaining active CaO, which may be determined by the characteristics of the flue gas, e.g., flow rate and CO₂ content.

The disclosed embodiments are not limited to the environment, or context, in which the CO₂ can be captured, in accordance with the reaction in Equation (1). For example, CO₂ may be captured from the atmosphere (e.g., air). For instance, floating objects (e.g., balloons) may be loaded with CaO powder, and used to deduct CO₂ concentration. In air, the concentration of CO₂ is typically low (e.g., less than 1%), as air is typically comprised of 78% N₂ and 21% O₂. Accordingly, CO₂ capturing and concentration in the form of calcium carbonate is necessary for efficient CO₂ fixing and eventual conversion to carbon (graphite).

CO₂ can also be captured from the exhaust gas of vehicles (e.g., vehicles using hydrocarbon fuels). For instance, CaO may be incorporated into the vehicle exhaust pipes to capture CO₂. In still other examples, the CO₂ can be captured from industrial flue gases, such as those from power plants fueled by coal or oils. In these examples, the CaO powder can be used via the blow reaction. For instance, CaO packed columns can be installed to remove CO₂ from the industrial flue gases.

At act (104), in some examples, the captured and concentrated carbon dioxide (CO₂)—in the form of calcium carbonate (CaCO₃)—is stored away until a time where it is required for producing graphite or graphene. In other cases, it may also be transported to a designated site, or location, where the CO₂ can be recovered with a view to producing graphite or graphene. For instance, the CaCO₃ can be transported using any type of vehicle, or otherwise any suitable transport or conveyance mechanism.

To that end, the storage and/or transport of the captured and concentrated carbon dioxide (CO₂) is possible because calcium carbonate (CaCO₃) provides a strong and stable capture medium that concentrates CO₂ for extended time periods.

At act (106), the captured and concentrated CO₂, in the form of CaCO₃, is recovered or released via input energy. This can be preformed using calcination (heating), in accordance with the reaction in Equation (2):

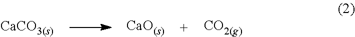

In some examples, the CaO, produced by the calcination process, is returned to the first step, to be re-used to capture additional CO₂. This is expressed by the return line, in process (100). Accordingly, CaO can be recycled in the process (100) in order to save CO₂ capturing and minimize solid waste discharge. In at least one example, the calcination temperature in Equation (2) is set in a range of between 800° C. to 900° C. under ambient pressures or certain vacuum environments, to remove and collect CO₂ produced out of the calcination system.

At act (108), the released CO₂, which is almost pure gas, can be converted to graphite (C) by reducing it with an active metal. Equation (3) shows an example reaction using zinc (Zn) as the active metal.

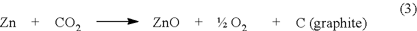

It will be understood that Equation (3) is a thermodynamically favorable reaction. From an Ellingham diagram, thermodynamically, both CO and CO₂ can be reduced to graphite (C) by more active metals/elements (e.g., Zn, Mn, Cr, Ca, Mg, Al, Ti, Si, and Mn), when the oxidation line of the metal or element is below the formation lines of CO and CO₂, under certain temperatures. Active metal tin (Sn) can also reduce CO and CO₂ to C (graphite) based on its half cell electrode potential. From a carbon phase diagram, the thermodynamically stable phase for carbon under relatively low pressure is graphite.

At act (110), in some examples, the active metals, used in Equation (3), can be recovered and recycled from their oxides using hydrometallurgy processes (e.g., acid leaching followed by electrowinning), as known in the art. Equations (4) and (5) show examples of this recovery process for zinc (Zn) and tin (Sn).

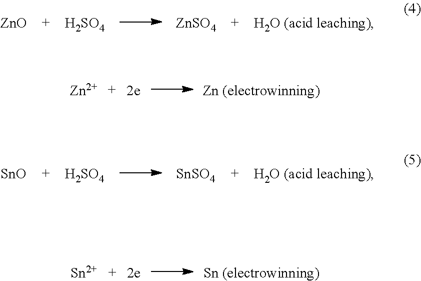

Accordingly, the recovered active metal can be re-used in Equation (3). This is expressed by the return line, in process (100). As metals can be recycled economically from the metal oxides, the presented process for fixing graphite (C) from CO₂, using active metals, is considered to be an economically viable and technologically feasible process.

### IV. Alternative Examples

While FIG. 1 (act (102)) and Equation (1) exemplify a case where carbon dioxide (CO₂) is captured using calcium oxide (CaO) powder, in other examples, it is appreciated that carbon dioxide (CO₂) can also be captured using any other metal oxide to produce a corresponding carbonate. In at least one example, the metal oxide is selected from a group consisting of MgO, FeO, MnO, ZnO, CuO, CaO, or any mixture thereof. In these examples, at act (106) (FIG. 1) and Equation (2), heating can also be used in a similar manner to recover the carbon dioxide (CO₂) from the carbonate. At act (108), and Equation (3), carbon dioxide (CO₂) can be reacted with an active metal to produce graphite (C).

### V. Experimental Set-Up

To demonstrate the efficacy of the process (100), an experimental set-up was arranged, whereby CO₂ gas flow was blown through a ceramic crucible filled with an active metal to obtain C (graphite, characterizing with XRD). Example parameters and conditions for converting CO₂ to graphite/graphene using various active metals are listed in Table 1, below.

TABLE 1
Carbon Fixing by Blowing CO₂ Gas through an Active Metal

| Metal used | | CO₂ | | Carbon |
|---|---|---|---|---|
| for converting | | gas flow, | Conversion | conversion |
| CO₂ to | Temperature, | liter/ | time, | efficiency |
| graphite | ° C. | minute | minutes | CE |
| Zn | 500 | 100 | 5 | 10.2% |
| | 600 | 60 | 20 | 30.6% |
| Sn | 280 | 100 | 20 | 7.6% |
| | 400 | 100 | 15 | 27.5% |
| Al | 780 | 100 | 20 | 18.6% |
| | 900 | 80 | 15 | 33.9% |
| Ti | 1000 | 100 | 120 | 1.6% |
| | 1780 | 80 | 15 | 26.7% |
| Si | 900 | 120 | 120 | 1.9% |
| | 1780 | 80 | 120 | 7.8% |

The carbon conversion efficiency (CE) can be calculated according to Equation (6).

$$CE = {m}_{graphite} / {m}_{carbon - in - carbon dioxide} \qquad ( 6 )$$

wherein m_{graphite} is the mass of graphite obtained after acid leaching and drying; m_{carbon-in-carbon dioxide} is the mass of carbon in CO₂ gas flow within certain conversion time. Carbon mass in CO₂ gas flow may determined from CO₂ mass using the ideal gas equation under stable volumic gas flow, in fixed conversion time (e.g., 1 to 120 minutes).

### VI. Interpretation

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A process for capture and conversion of carbon dioxide, comprising:
capturing carbon dioxide (CO₂) using calcium oxide (CaO) to produce calcium carbonate (CaCO₃);
recovering the carbon dioxide (CO₂) from the calcium carbonate (CaCO₃); and
reacting the carbon dioxide (CO₂) with an active metal to produce graphite (C).

2. The process of claim 1, wherein recovering the carbon dioxide (CO₂) from the calcium carbonate (CaCO₃) is performed using calcination.

3. The process of claim 1, wherein the active metal is selected from the group consisting of zinc (Zn), tin (Sn), manganese (Mn), Chromium (Cr), calcium (Ca), magnesium (Mg), aluminum (Al), titanium (Ti) and silicon (Si).

4. The process of claim 1, wherein an oxide of the active metal is produced as a byproduct of reacting the carbon dioxide (CO₂) with the active metal, and the process further comprises recovery of the active metal from its oxide using a hydrometallurgy processes.

5. The process of claim 4, wherein the hydrometallurgy process comprises acid leaching followed by electrowinning.

6. The process of claim 4, wherein the recovered active metal is reused by reacting it with additional carbon dioxide (CO₂) to produce additional graphite (C).

7. The process of claim 1, wherein calcium oxide (CaO) is generated as a byproduct of recovering the carbon dioxide (CO₂) from the calcium carbonate (CaCO₃), and the process further comprises reusing the calcium oxide (CaO) to capture additional carbon dioxide (CO₂).

8. The process of claim 1, wherein prior to recovery of the carbon dioxide (CO₂), the process further comprises one or more of storing and transporting the captured and concentrated carbon dioxide (CO₂).

9. The process of claim 1, wherein the calcium oxide (CaO) comprises solid particles in a range of 1 nm to 100 microns.

10. A process for capture and conversion of carbon dioxide, comprising:
capturing carbon dioxide (CO₂) using a metal oxide to produce a carbonate;
recovering the carbon dioxide (CO₂) from the carbonate; and
reacting the carbon dioxide (CO₂) with an active metal to produce graphite (C).

11. The process of claim 10, wherein the metal oxide is selected from the group consisting of MgO, FeO, MnO, ZnO, CuO, CaO, and mixtures thereof.

12. The process of claim 10, wherein recovering the carbon dioxide (CO₂) from the calcium carbonate is performed using calcination.

13. The process of claim 10, wherein the active metal is selected from the group consisting of zinc (Zn), tin (Sn), manganese (Mn), Chromium (Cr), calcium (Ca), magnesium (Mg), aluminum (Al), titanium (Ti) and silicon (Si).

14. The process of claim 10, wherein an oxide of the active metal is produced as a byproduct of reacting the carbon dioxide (CO₂) with the active metal, and the process further comprises recovery of the active metal from its oxide using a hydrometallurgy processes.

15. The process of claim 14, wherein the hydrometallurgy process comprises acid leaching followed by electrowinning.

16. The process of claim 14, wherein the recovered active metal is reused by reacting it with additional carbon dioxide (CO₂) to produce additional graphite (C).

17. The process of claim 10, wherein metal oxide is generated as a byproduct of recovering the carbon dioxide (CO₂) from the carbonate, and the process further comprises reusing the metal oxide to capture additional carbonate.

18. The process of claim 10, wherein prior to recovery of the carbon dioxide (CO₂), the process further comprises one or more of storing and transporting the captured and concentrated carbon dioxide (CO₂).
